(19) United States
(12) Patent Application Publication
(10) Pub. No.: US 2025/0046070 A1
(43) Pub. Date: Feb. 6, 2025

(54) CHARACTER COORDINATE EXTRACTION METHOD AND APPARATUS, DEVICE, MEDIUM, AND PROGRAM PRODUCT

(71) Applicants: CHINA MOBILE (SUZOU) SOFTWARE TECHOLOGY CO., LTD., Suzhou, Jiangsu (CN); CHINA MOBILE COMMUNICATIONS GROUP CO., LTD., Beijing (CN)

(72) Inventor: Xiaoshuang LIU, Suzhou (CN)

(21) Appl. No.: 18/719,861

(22) PCT Filed: Nov. 18, 2022
(86) PCT No.: PCT/CN2022/132993

§ 371 Date: Jun. 14, 2024

(51) Int. Cl. G06V 10/82; G06V 30/18; G06V 30/19

(52) U.S. Cl. CPC G06V 10/82; G06V 30/18076; G06V 30/19147; G06V 30/19173; G06V 30/1918

(57) ABSTRACT

Embodiments of the present application disclose a character coordinate extraction method and apparatus, a device, a medium and a program product. The method comprises: inputting a target text image into a feature extraction backbone network, and obtaining character segmentation features and text line segmentation features by means of feature fusion by different layers in the backbone network; respectively inputting the character segmentation features and the text segmentation features into a character segmentation module and a text line segmentation module, and obtaining a character segmentation heat map and a text segmentation heat map of the target text image, wherein the character segmentation module and the text line segmentation module form a segmentation network model; and calculating coordinates of a single character in the target text image according to the character segmentation heat map and the text line segmentation heat map. According to the embodiments of the present application, repeated extraction of features is reduced; high robustness is achieved for character segmentation; convergence of the network is accelerated, and the segmentation efficiency of the network is improved; the accuracy of single-character coordinate extraction is improved.

### CROSS-REFERENCE TO RELATED APPLICATION

This application claims the priority to Chinese Patent Application No. 202111561174.1 filed on Dec. 16, 2021 by China Mobile (Suzhou) Software Technology Co., Ltd. and China Mobile Communications Group Co., Ltd., and entitled “Character Coordinate Extraction Method and Apparatus, Device and Storage Media”, the disclosure of which is hereby incorporated by reference in its entirety.

### TECHNICAL FIELD

The embodiments of the present disclosure relate to the technical field of image recognition, and in particular to a character coordinate extraction method and apparatus, a device, a medium and a program product.

### BACKGROUND

At present, a known method for extracting coordinates of an individual character in a text mainly includes: a target image is segmented to obtain each independent connective body, it is determined whether each connective body contains touching characters, the contour of the touching characters is detected to obtain a center position of a closed area existing in the characters, and the touching characters are segmented to obtain a position of the individual character. Alternatively, the method includes: a text line recognition network based on the attention mechanism is designed and a recognition model is trained, a text line image to be segmented is input into the recognition model, and a segmentation result of the individual character is calculated through a weighted probability distribution of the attention mechanism to finally obtain position information and a recognition result of each character.

According to the technical scheme, the target image is firstly segmented to obtain each independent connective body, and then it is determined whether each connective body contains touching characters according to the width and height of a character area occupied by each character in the target image. When there is a connective body containing touching characters, the central position of the closed area existing in the touching characters is determined, the central position of the touching characters is obtained according to the central position of the closed area, and the touching characters are segmented to obtain the position information of the individual character. In the technical scheme, whether there are touching characters is determined by determining the width and height of the characters in the connective body. However, for Chinese and English mixed texts, the width of an English character may be different from the width of a Chinese character, thus whether the characters are touching cannot be determined by the widths. In addition, the center position of the closed area needs to be used to segment the touching characters, but most of the common characters do not contain such a closed area, so it has great limitations.

Furthermore, according to another technical scheme, text line training data is firstly collected; sizes of the images are normalized; augmentation is performed on the training images; a text line recognition model with attention mechanism is created; a recognition model is obtained by training through a large number of training data; a text line image to be segmented is input into the recognition model; and a segmentation result of an individual character is calculated through a weighted probability distribution of the attention mechanism. The method based on the attention mechanism in this scheme has the problem of attention drift, which will affect the recognition result. Moreover, the method based on the attention mechanism is mainly used to train the recognition model. The accuracy of the method used for the segmentation of the individual character is greatly affected by the recognition model. When there is a missed recognition, it will affect the accuracy of the segmentation of the individual character, and the robustness is poor.

### SUMMARY

In view of the above problems, the embodiments of the present disclosure provide a character coordinate extraction method and apparatus, a device, a medium and a program product, which have wider adaptability and higher robustness.

The technical schemes provided by the embodiments of the present disclosure are as follows.

The embodiments of the present disclosure provide a method for extracting coordinates of characters, wherein the method includes:

a target text image is input into a feature extraction backbone network, and a character segmentation feature and a text line segmentation feature are acquired through feature fusion by different layers in the backbone network;

the character segmentation feature and the text line segmentation feature are input respectively into a character segmentation module and a text line segmentation module, and a character segmentation heat map and a text line segmentation heat map of the target text image are acquired, where the character segmentation module and the text line segmentation module form a segmentation network model; and

coordinates of an individual character are calculated in the target text image according to the character segmentation heat map and the text line segmentation heat map.

The embodiments of the present disclosure further provide an apparatus for extracting coordinates of characters, wherein the device includes:

a target text image input module configured to input a target text image into a feature extraction backbone network;

a segmentation feature acquiring module configured to acquire a character segmentation feature and a text line segmentation feature;

a segmentation feature input module configured to input the character segmentation feature and the text line segmentation feature respectively into a character segmentation module and a text line segmentation module;

a character segmentation heat map module configured to acquire a character segmentation heat map of the target text image;

a text segmentation heat map module configured to acquire a text line segmentation heat map of the target text image; and

a coordinates calculation module configured to calculate coordinates of an individual character in the target text image according to the character segmentation heat map and the text line segmentation heat map.

The embodiments of the present disclosure further provide a device for extracting coordinates of characters, the apparatus includes: a processor, a memory, a communication interface and a communication bus, where the processor, the memory and the communication interface perform mutual communication through the communication bus;

the memory is configured to store at least one executable instruction causing the processor to perform the method for extracting coordinates of characters of the above-mentioned any character.

The embodiments of the present disclosure further provide a computer-readable storage medium having stored thereon at least one executable instruction that, when executed on a device/apparatus for extracting coordinates of an individual character, causes the device/apparatus for extracting coordinates of an individual character to perform the method for extracting coordinates of characters in any of the above method embodiments.

The embodiments of the present disclosure further provide a computer program including computer readable codes that, when executed on an electronic device, cause a processor of the electronic device to perform the method for extracting coordinates of characters in any of the above method embodiments.

The embodiments of the present disclosure further provide a computer program product including computer readable codes, or a non-volatile computer-readable storage medium carrying the computer readable codes. When the computer readable codes are executed on a processor of an electronic device, the processor of the electronic device is caused to perform the method for extracting coordinates of characters in any of the above method embodiments.

In the embodiments of the present disclosure, an individual character segmentation module, a text line area segmentation module, and a shared feature extraction backbone network are fused into a neural network, thereby reducing repeated feature extraction; the segmentation of text lines and character areas is implemented at the same time through a parallel segmentation network model, which improves the efficiency of feature segmentation; and the robustness of character segmentation is improved, and the accuracy of extracting the coordinates of the individual character is improved.

The above description is only an overview of the technical schemes of the embodiments of the present disclosure. In order to better understand the technical means of the embodiments of the present disclosure so that it can be implemented in accordance with the content of the description, and in order to make the above and other purposes, characteristics and advantages of the embodiments of the present disclosure to be understood more clearly and easily, specific implementations of the present disclosure are described below.

It should be understood that the above general description and the following detailed description are only for illustrative and explanatory purposes and are intended to limit the present disclosure. Other features and aspects of the present disclosure will become clear in accordance with the following detailed description of exemplary embodiments with reference to the accompanying drawings.

### BRIEF DESCRIPTION OF THE DRAWINGS

The drawings herein incorporated in and forming part of the specification illustrate embodiments conforming to the present disclosure and are used together with the specification to illustrate the technical schemes of the present disclosure.

FIG. 1 shows a flowchart of an embodiment of a method for extracting coordinates of characters provided in the present disclosure.

FIG. 2 shows a flowchart of acquiring a character segmentation feature and a text line segmentation feature provided in the present disclosure.

FIG. 3 shows a flowchart of acquiring a character segmentation heat map and a text line segmentation heat map of a target text image provided in the present disclosure.

FIG. 4 shows a flowchart of calculating coordinates of an individual character in a target text image provided by an embodiment of the present disclosure.

FIG. 5 shows a flowchart of extracting coordinates of the individual character from CTC provided in the present disclosure.

FIG. 6 shows a flowchart of training a segmentation network model provided and preparing training data in the present disclosure.

FIG. 7 shows a flowchart of an embodiment of a method for extracting coordinates of characters provided in the present disclosure.

FIG. 8 shows a network architecture diagram in a method for extracting coordinates of characters provided in the present disclosure.

FIG. 9 shows a schematic diagram of image annotation in a method for extracting coordinates of characters provided in the present disclosure.

FIG. 10 shows a schematic diagram of a segmentation network model in a method for extracting coordinates of characters provided in the present disclosure.

FIG. 11 shows a schematic diagram of bounding box position information in a method for extracting coordinates of characters provided in the present disclosure.

FIG. 12 shows a flowchart of extracting coordinates based on individual character segmentation in a method for extracting coordinates of characters provided in the present disclosure.

FIG. 13 shows a flowchart of extracting coordinates of the individual character by a watershed algorithm in a method for extracting coordinates of characters provided in the present disclosure.

FIG. 14 shows a heat map of text lines where boundary blurring causes the segmentation failure of the watershed algorithm.

FIG. 15 shows a flowchart of CTC-based text recognition in a method for extracting coordinates of characters provided in the present disclosure.

FIG. 16 shows a flowchart of CTC-based recognition results in a method for extracting coordinates of characters to reverse coordinate extraction provided in the present disclosure.

FIGS. 17 to 21 show schematic structural diagrams of an apparatus for extracting coordinates of characters provided in the present disclosure.

FIG. 22 shows a schematic diagram of a device for extracting coordinates of an individual character provided in the present disclosure.

### DETAILED DESCRIPTION

Various exemplary embodiments, features and aspects of the present disclosure will be described in detail below with reference to the accompanying drawings. The same signs in the drawings denote functionally identical or similar elements. Although various aspects of the embodiments are shown in the drawings, the drawings need not be drawn to scale unless specifically noted.

The special word “exemplary” here means “used as an example or embodiment, or illustrative”. Any embodiments illustrated herein as “exemplary” need not be construed as superior to or better than other embodiments.

The term “and/or” used herein merely indicates an association relationship that describes associated objects, indicating three relationships. For example, A and/or B may indicate three cases where A exists alone, both A and B exist, and B exists alone. In addition, the term “at least one” used herein denotes any one of the plurality elements or any combination of at least two of the plurality of elements. For example, including at least one of A, B or C may denote including any one or more elements selected from the set consisting of A, B, and C.

In addition, in order to better illustrate the present disclosure, numerous specific details are given in the following specific embodiments. It will be appreciated by those skilled in the art that the present disclosure can be implemented without certain specific details. In some examples, methods, means, components and circuits familiar to those skilled in the art have not been described in detail in order to highlight the gist of the present disclosure.

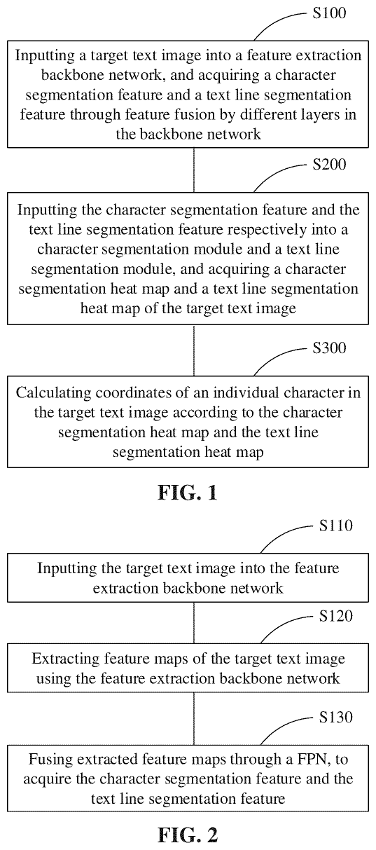

FIG. 1 shows a flowchart of an embodiment of a method for extracting coordinates of characters provided in the present disclosure, the method being performed by a device for extracting coordinates of an individual character. As shown in FIG. 1, the method includes the following operations.

At S100, a target text image is input into a feature extraction backbone network, and a character segmentation feature and a text line segmentation feature are acquired through feature fusion by different layers in the backbone network.

The feature extraction backbone network refers to a main network of a deep convolutional neural network used to extract picture features. The feature extraction backbone network includes, but is not limited to, a Residual Network (ResNet) and a Selective Kernel Network (SKNet).

At S200, the character segmentation feature and the text line segmentation feature are input respectively into a character segmentation module and a text line segmentation module, and a character segmentation heat map and a text line segmentation heat map of the target text image are acquired.

The character segmentation module and the text line segmentation module form a segmentation network model.

At S300, coordinates of an individual character in the target text image are calculated according to the character segmentation heat map and the text line segmentation heat map.

The coordinates of the individual character refer to coordinate position information of each character in a character string.

In this embodiment, an individual character segmentation module, a text line segmentation module and a shared feature extraction backbone network are fused into a neural network, thereby reducing repeated feature extraction.

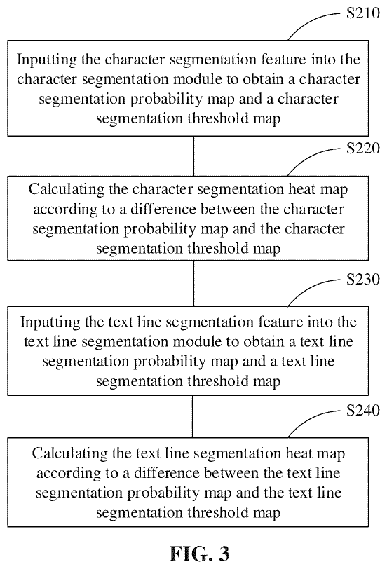

Based on the aforementioned embodiment, the operation of inputting the target text image into the feature extraction backbone network, to acquire the character segmentation feature and the text line segmentation feature through feature fusion by different layers in the backbone network, can be implemented by FIG. 2. FIG. 2 shows a flowchart of acquiring a character segmentation feature and a text line segmentation feature provided in the present disclosure, the method being performed by a device for extracting coordinates of an individual character. As shown in FIG. 2, the method includes the following operations.

At S110, the target text image is input into the feature extraction backbone network.

At S120, feature maps of the target text image are extracted using the feature extraction backbone network.

At S130, extracted feature maps are fused through a Feature Pyramid Network (FPN) for object detection, to acquire the character segmentation feature and the text line segmentation feature.

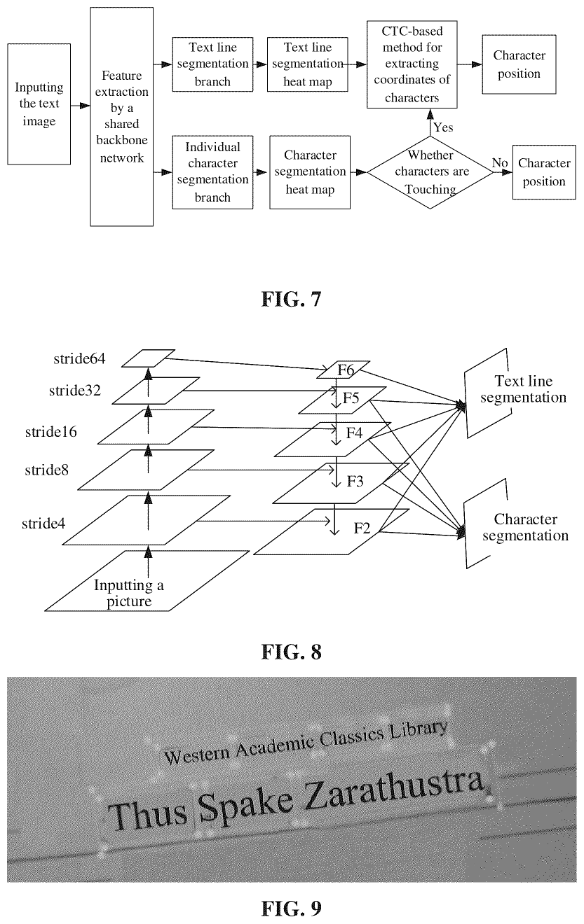

It is worth noting that, as shown in FIG. 7 to FIG. 9, since the low-level features in the convolutional neural network have higher resolution, the low-level features contain more position and detail information, but because they are subjected to less convolutions, they have less semantics and more noises. Furthermore, high-level features have stronger semantic information, but the resolution is very low, and the ability to perceive details is poor. Fusion of high-level and low-level features can improve the robustness of the network.

Specifically, the target text image shown in FIG. 9 is input into the feature extraction backbone network. As shown in FIG. 8, five feature maps stride4, stride8, stride16, stride32 and stride64 are extracted from the feature extraction backbone network and fused by the FPN, and four feature maps F2, F3, F4 and F5 after the FPN are concatenated as the character segmentation feature obtained by the character segmentation; the five feature graphs F2, F3, F4, F5 and F6 after FPN are concatenated as the text line segmentation feature obtained by the text line segmentation.

Further, the FPN fusion method is used to fuse 5 low-level features with 5 high-level features to obtain F2 (the size is ¼ of the original image), F3 (⅛), F4 ( 1/16), F5 ( 1/32) and F6 ( 1/64), respectively. F3 is up-sampled by 2 times, F4 is up-sampled by 4 times, F5 is up-sampled by 8 times, and F6 is up-sampled by 16 times. The sampled feature maps are all ¼ of the original image. Then, the five feature maps F2, F3, F4, F5 and F6 are concatenated to obtain a feature Fchar=C(F2, F3, F4, F5, F6) for character segmentation, and the four feature maps F2, F3, F4 and F5 are concatenated to obtain a feature map Fline=C(F2, F3, F4, F5) for text line segmentation.

Based on the aforementioned embodiment, the operation of inputting the character segmentation feature and the text line segmentation feature respectively into the character segmentation module and the text line segmentation module, to acquire the character segmentation heat map and the text line segmentation heat map of the target text image, can be implemented by FIG. 3. FIG. 3 shows a flowchart of acquiring a character segmentation heat map and a text line segmentation heat map of a target text image provided in the present disclosure, the method includes the following operations.

At S210, the character segmentation feature is input into the character segmentation module to obtain a character segmentation probability map and a character segmentation threshold map.

The character segmentation module can use a DBNet network structure to obtain the threshold map.

At S220, the character segmentation heat map is calculated according to a difference between the character segmentation probability map and the character segmentation threshold map.

At S230, the text line segmentation feature is input into the text line segmentation module to obtain a text line segmentation probability map and a text line segmentation threshold map.

At S240, the text line segmentation heat map is calculated according to a difference between the text line segmentation probability map and the text line segmentation threshold map.

Specifically, the fused feature F=C(F2, F3, F4, F5, F6) is respectively input into two branches of the segmentation network. The first branch is used to predict a probability map and a threshold map of the entire text line area to obtain text line position information for Connectionist Temporal Classification (CTC)-based text recognition. The other branch is used to predict the probability map and threshold map from each character area to the character image to obtain the position information of the character area.

Specifically, the prediction samples are output as 4 segmented images through model prediction, and the heat map in this proposal is obtained through a difference map between the probability map and the threshold segmentation map. After the input image passes through two segmentation branches, one branch obtains the text line segmentation probability map Pₜₑₓₜₗᵢₙₑ and the text line segmentation threshold map Tₜₑₓₜₗᵢₙₑ of the image. The other branch obtains the character segmentation probability map P_{char}, and the character segmentation threshold map T_{char}, Rₜₑₓₜᵢₙₑ and R_{char} are obtained by taking the difference between the probability map and the corresponding threshold map. The calculation formulas are shown in formulas (1) to (2)

$${R}_{char} = {P}_{char} - {T}_{char} \qquad ( 1 )$$

$${R}_{textline} = {P}_{textline} - {T}_{textline} \qquad ( 2 )$$

When the difference images Rₜₑₓₜₗᵢₙₑ and R_{char}, are represented in the form of the heat map, the character segmentation heat map and the text line segmentation heat map are obtained.

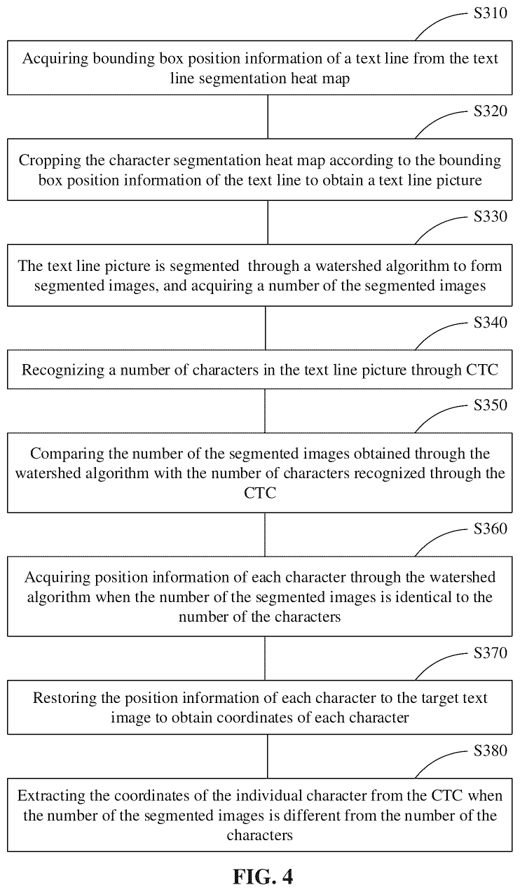

Based on the aforementioned embodiment, the operation of calculating the coordinates of the individual character in the target text image according to the character segmentation heat map and the text line segmentation heat map can be implemented by FIG. 4. FIG. 4 shows a flowchart of calculating coordinates of an individual character in a target text image provided by an embodiment of the present disclosure. As shown in FIG. 4, the method includes the following operations.

At S310, bounding box position information of a text line is acquired from the text line segmentation heat map.

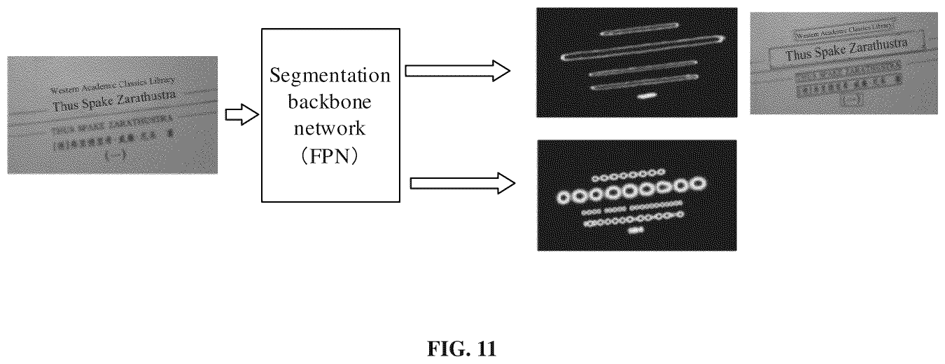

The bounding box position information of each text line can be obtained from the text line segmentation heat map, as shown in FIG. 11.

At S320, the character segmentation heat map is cropped according to the bounding box position information of the text line to obtain a text line picture.

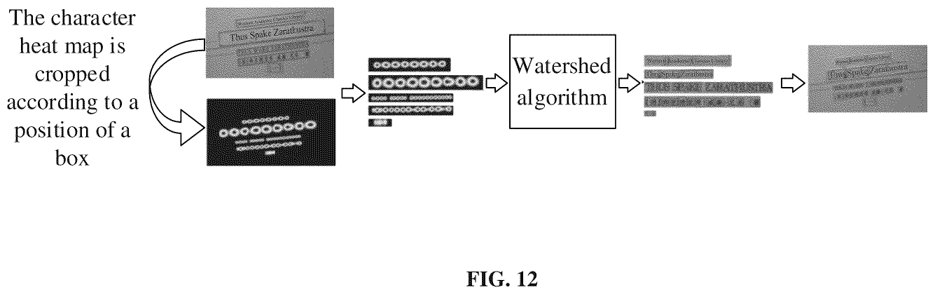

Specifically, the character heat map is cropped according to the position information of the text line to obtain a picture cut into text lines as shown in FIG. 12.

At S330, the text line picture is segmented through a watershed algorithm to form segmented images, and a number of the segmented images is acquired.

At S340, a number of characters is recognized in the text line picture through CTC.

At S350, the number of the segmented images obtained through the watershed algorithm is compared with the number of characters recognized through the CTC.

At S360, position information of each character is acquired through the watershed algorithm when the number of the segmented images is identical to the number of the characters.

At S370, the position information of each character is restored to the target text image to obtain coordinates of each character;

At S380, the coordinates of the individual character are extracted from the CTC when the number of the segmented images is different from the number of the characters.

The watershed algorithm is a customary segmentation method for image areas.

In the process of segmentation, it will take the similarity between neighboring pixels as an important reference, so that the pixels that are close in space and close in gray value are connected to each other to form a closed contour.

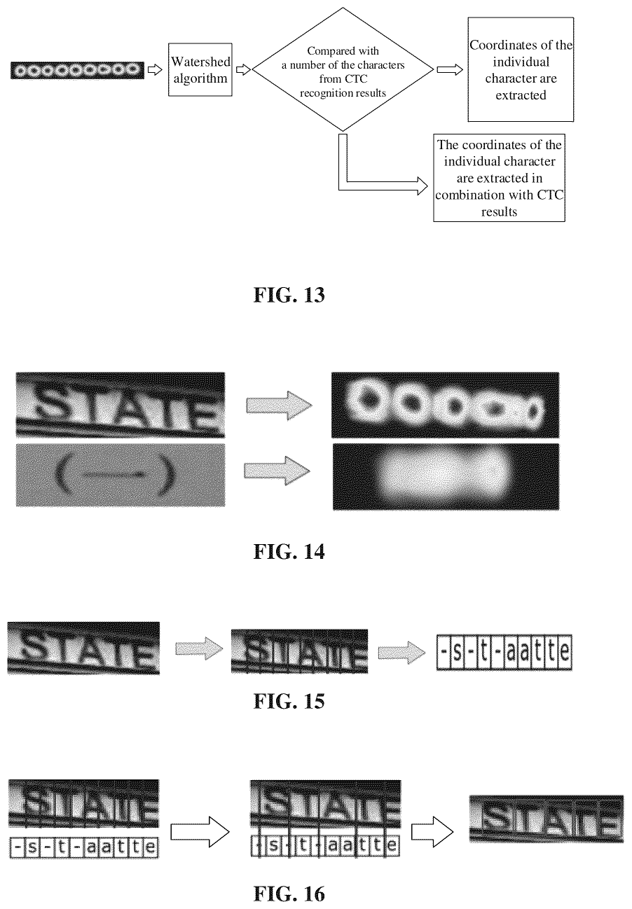

Specifically, segmentation is performed by the customary watershed algorithm. If the segmentation is successful, the position information of each character can be obtained directly, and the coordinates of the individual character can be obtained by restoring the position information to the original image. The flow of determining whether characters are touching based on the watershed algorithm is shown in FIG. 13.

For example, when the segmentation through the watershed algorithm fails, it is indicated that there may be touching characters in the segmented image, and at this time, the coordinates of the individual character can be extracted by the CTC-based recognition result.

For example, the design of a text line segmentation and character segmentation network model may include: obtaining a feature map for text line segmentation through the segmentation network model, and inputting the fused feature into two segmentation network branches respectively. The first branch is used to predict a probability map and a threshold map of the entire text line area to obtain text line position information for CTC-based text recognition; and the other branch is used to predict the probability map and threshold map from each character area to the character image to obtain the position information of the character area.

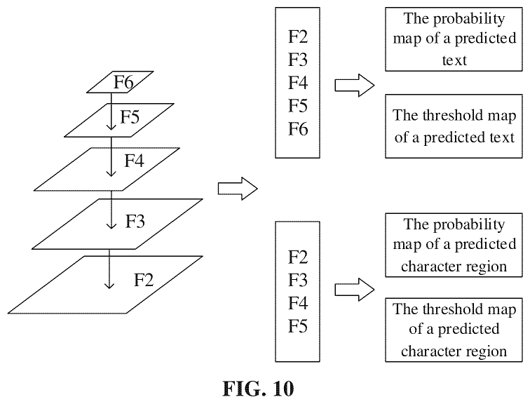

As shown in FIG. 10, the prediction samples are output as 4 segmented images through model prediction, and the heat maps for character and text line segmentations are obtained through calculation. The bounding box position information of each text line can be obtained through the text line segmentation heat map. The character heat map is cropped according to the position information of the text line to obtain a picture cut into text lines, and then segmented through the customary watershed algorithm. If the segmentation is successful, the position information of each character can be directly obtained. When the segmentation through the watershed calculation fails, it means that there may be touching characters in the segmented image. At this time, the coordinates of the individual character can be extracted through the CTC-based recognition result.

The embodiment adopts two parallel methods in the process of extracting character coordinates so that the character segmentation has high robustness. Through the first branch, the segmented text line information is combined with the CTC to obtain text content and character number. Through the individual character segmentation method provided by the second branch, the segmented image is obtained, and the position information of the coordinates of the individual character is obtained. When there are not touching characters in the segmented image, the result is directly output. The method has high robustness and can solve the problem of segmenting touching characters in the segmentation network.

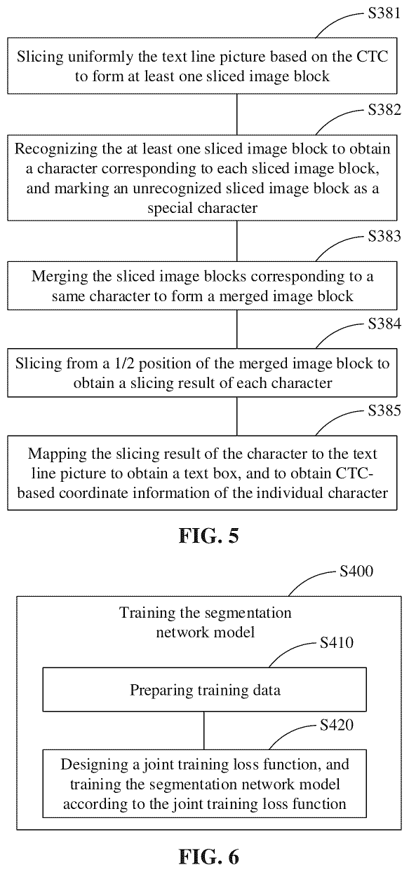

Based on the aforementioned embodiments, the operation of extracting the coordinates of the individual character from the CTC when the number of the segmented images is different from the number of the characters can be implemented by FIG. 5. FIG. 5 shows a flowchart of extracting coordinates of the individual character from CTC provided in the present disclosure. The method is performed by a device for extracting coordinates of an individual character. As shown in FIG. 5, the method includes the following operations.

At S381, the text line picture is sliced uniformly based on the CTC to form at least one sliced image block.

At S382, the at least one sliced image block is recognized to obtain a character corresponding to each sliced image block, and an unrecognized sliced image block is marked as a special character.

At S383, the sliced image blocks corresponding to a same character are merged to form a merged image block.

At S384, slicing is performed from a ½ position of the merged image block to obtain a slicing result of each character.

At S385, the slicing result of the character is mapped to the text line picture to obtain a text box, and to obtain CTC-based coordinate information of the individual character.

As shown in FIG. 14, the coordinates of the individual character are extracted from the CTC for text lines that fail to be segmented by the watershed algorithm.

The CTC is a loss calculation method that does not require alignment. The CTC is commonly used in the process of character content recognition. The operations are shown in FIG. 15. First, the picture is sliced uniformly to obtain the probability that each block belongs to a certain character. Unrecognized image blocks are marked as special characters “-”. As shown in FIG. 15, the recognition result “-s-t-aatte” is obtained after the text picture passes through the CTC, and then the final recognition result “state” is obtained through deduplication.

The flowchart of the CTC-based method for extracting coordinates of the individual character is shown in FIG. 16. As shown in FIG. 16, in this embodiment, the image blocks corresponding to the same character in the CTC intermediate result are merged, and the merged characters are sliced. The unrecognized character result “-” is sliced uniformly on both sides, i.e., is sliced from ½ position of the character in the segmentation process, so as to obtain the segmentation result of each character. The segmentation result of the character is mapped to the text line picture to obtain the text box, and finally the CTC-based coordinate information of the individual character is obtained.

The embodiment adopts two parallel methods in the process of extracting character coordinates so that the character segmentation has high robustness. Through the first branch, the segmented text line information is combined with the CTC to obtain text content and character number. When individual characters obtained through segmentation by branch 2 are touching, the coordinates are checked by a CTC-based individual character coordinate check method to obtain coordinate information of the individual character. Through the method for individual character segmentation provided by the second branch, the segmented image is obtained, and the position information of the individual character is obtained. When there are no touching characters in the segmented image, the result is directly output. The method has high robustness and can solve the problem of segmenting touching characters in the segmentation network. At the same time, the shared backbone network is enabled to reduce the repeated extraction of features.

In the embodiments, the segmentation of both the text line and the character area is implemented simultaneously through the parallel network model, and two methods for extracting text coordinates of the individual character are used for the two segmentation branches respectively. The combination of the two methods can solve the coordinate extraction of the touching characters.

FIG. 6 shows a flowchart of training a segmentation network model and preparing training data provided in the present disclosure, the method being performed by a device for extracting coordinates of an individual character. As shown in FIG. 6, the method further includes the following operation S400.

At S400, the segmentation network model is trained, wherein before the training the segmentation network model, the method further includes operations S410 and S420.

At S410, training data is prepared.

The training data includes position information of each character and position information of an entire text line; the position information of each character is configured to train an individual character segmentation module; and the position information of the entire text line is configured to train the text line area segmentation module.

At S420, a joint training loss function is designed, and the segmentation network model is trained according to the joint training loss function.

A formula for calculating the joint training loss function is formula (3):

$$Loss = {αloss}_{char} + {βloss}_{textline} \qquad ( 3 )$$

where α and β are constant coefficients;

each of loss_{char} and lossₜₑₓₜₗᵢₙₑ includes a segmentation graph loss L_{S} and a threshold map loss Lₜ of the character and the text line, and loss_{char} and lossₜₑₓₜₗᵢₙₑ can be calculated by formulas (4) to (5), respectively:

$${loss}_{char} = {α}_{1} {L}_{S 1} + {β}_{1} {L}_{t 1} \qquad ( 4 )$$

$${loss}_{textline} = {α}_{2} {L}_{S 2} + {β}_{2} {L}_{t 2} \qquad ( 5 )$$

where α₁, α₂, β₁, and β₂ are constant coefficients.

The segmentation probability map in the joint training loss function adopts a bi-classification cross-entropy loss function, and inputs of loss functions L_{S1} and L_{S2} are a sample prediction probability map and a sample true label map. Herein, L_{S1} and L_{S2} can be represented by formula (6);

$${L}_{S 1} = {L}_{S 2} = {\sum }_{i ∈ {S}_{1}} {y}_{i} log {x}_{i} + ( 1 - {y}_{i} ) log ( 1 - {x}_{i} ) \qquad ( 6 )$$

where Sᵢ is a sample set, xᵢ is a probability value of a pixel in the sample prediction map, yᵢ is a true value of the pixel of a true label of a sample;

inputs of loss functions Lₜ₁ and Lₜ₂ are a threshold map of a predicted text line and a sample true label map of the predicted text, and the threshold map adopts L1 distance loss function, as shown in formula (7);

$${L}_{t 1} = {L}_{t 2} = {\sum }_{i ∈ {R}_{d}} \vert {y}_{i}^{*} - {x}_{i}^{*} \vert \qquad ( 7 )$$

where R_{d} is a pixel index set in the threshold map; yᵢ⁺ is the sample true label map, xᵢ* is the threshold map of the predicted text line.

It is worth noting that the difference between a predicted value and a true value of an individual sample is called a loss. The smaller the loss, the better the model. In this proposal, because characters and text lines are segmented in the training process at the same time, there are two segmentation loss functions, i.e., character segmentation loss loss_{char} and text box segmentation loss lossₜₑₓₜₗᵢₙₑ. In order to improve the accuracy of the segmentation network, the scheme designs the joint training loss function where the loss function of the segmentation network is the addition of the character segmentation loss loss_{char} and text box segmentation loss lossₜₑₓₜₗᵢₙₑ, as shown in formula (3). Herein, α and β are constant coefficients and can be adjusted empirically.

In the embodiment, the character area and the text line area are simultaneously segmented, and the loss function is jointly trained through the character segmentation branch and the text line segmentation branch, thus the convergence of the network is accelerated to achieve a better segmentation effect.

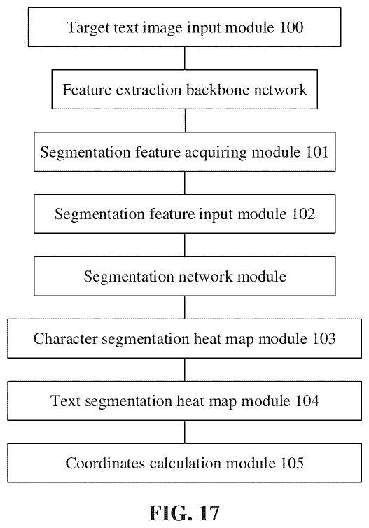

FIG. 17 shows a schematic structural diagram of an apparatus for extracting coordinates of characters provided in the present disclosure. As shown in FIG. 17, the apparatus includes:

a target text image input module 100 configured to input a target text image into a feature extraction backbone network;

a segmentation feature acquiring module 101 configured to acquire a character segmentation feature and a text line segmentation feature;

a segmentation feature input module 102 configured to input the character segmentation feature and the text line segmentation feature respectively into a character segmentation module and a text line segmentation module, where the character segmentation module and the text line segmentation module form a segmentation network model;

a character segmentation heat map module 103 configured to acquire a character segmentation heat map of the target text image;

a text segmentation heat map module 104 configured to acquire a text segmentation heat map of the target text image;

a coordinates calculation module 105 configured to calculate coordinates of an individual character in the target text image according to the character segmentation heat map and the text segmentation heat map.

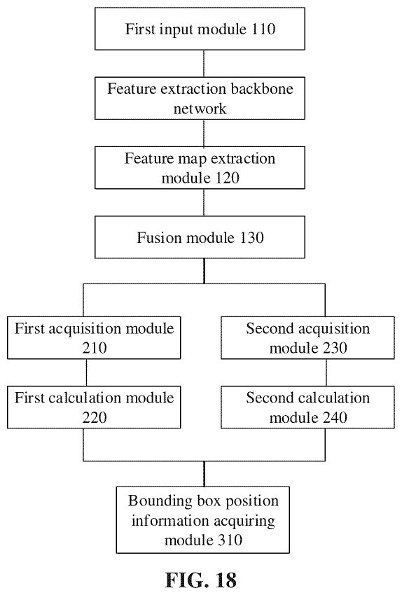

As shown in FIG. 18, in some embodiments, the apparatus further includes:

a first input module 110 configured to input the target text image into the feature extraction backbone network;

a feature map extraction module 120 configured to extract feature maps of the target text image using the feature extraction backbone network;

a fusion module 130 configured to fuse the extracted feature maps through a FPN to acquire the character segmentation feature and the text line segmentation feature.

In some embodiments, the apparatus further includes:

a first acquisition module 210 configured to input the character segmentation feature into the character segmentation module to obtain a character segmentation probability map and a character segmentation threshold map;

a first calculation module 220 configured to calculate the character segmentation heat map according to a difference between the character segmentation probability map and the character segmentation threshold map;

a second acquisition module 230 configured to input the text line segmentation feature into the text line area segmentation module to obtain a text line segmentation probability map and a text line segmentation threshold map;

a second calculation module 240 configured to calculate the text line segmentation heat map according to a difference between the text line segmentation probability map and the text line segmentation threshold map.

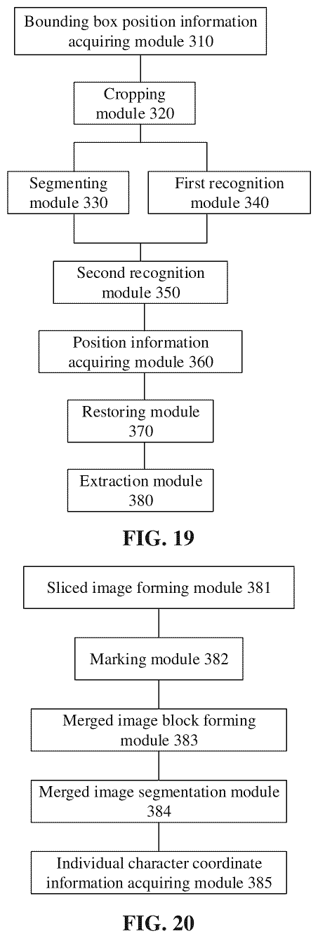

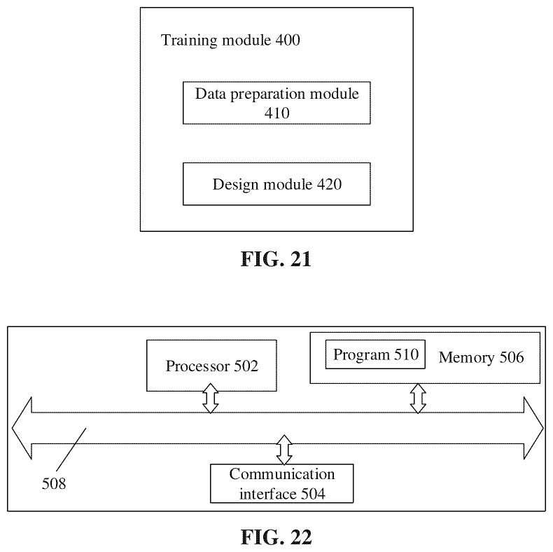

In some embodiments, as shown in FIG. 18 to FIG. 21, the apparatus further includes:

a bounding box position information acquiring module 310 configured to acquire bounding box position information of a text line from the text line segmentation heat map;

a cropping module 320 configured to crop the character segmentation heat map according to the bounding box position information of the text line to obtain a text line picture;

a segmenting module 330 configured to segment the text line picture through a watershed algorithm to form segmented images, and acquire a number of the segmented images;

a first recognition module 340 configured to recognize a number of characters in the text line picture through CTC.

a second recognition module 350 configured to compare the number of the segmented images obtained through the watershed algorithm with the number of characters recognized through the CTC;

a position information acquiring module 360 configured to acquire position information of each character through the watershed algorithm when the number of the segmented images is identical to the number of characters;

a restoring module 370 configured to restore the position information of each character to the target text image to obtain coordinates of each character;

an extraction module 380 configured to extract the coordinates of the individual character from the CTC when the number of the segmented images is different from the number of the characters.

In some embodiments, the apparatus further includes:

a sliced image forming module 381 configured to uniformly slice the text line picture based on the CTC to form at least one sliced image block,

a marking module 382 configured to recognize the at least one sliced image block to obtain a character corresponding to each sliced image block, and mark an unrecognized sliced image block as a special character;

a merged image block forming module 383 configured to merge the sliced image blocks corresponding to a same character to form a merged image block;

a merged image segmentation module 384 configured to segment from a ½ position of the merged image block to obtain a slicing result of each character;

an individual character coordinate information acquiring module 385 configured to map the slicing result of the character to the text line picture to obtain a text box, and obtain CTC-based coordinate information of the individual character.

In some embodiments, the apparatus further includes:

a training module 400 configured to train the segmentation network model;

the training module 400 includes:

a data preparation module 410 configured to prepare training data, wherein the training data includes position information of each character and position information of an entire text line; the position information of each character is configured to train an individual character segmentation module; and the position information of the entire text line is configured to train the text line area segmentation module.

a design module 420 configured to design a joint training loss function, and train the segmentation network model according to the joint training loss function; wherein the joint training loss function may be described in the aforementioned embodiment and will not be described here.

FIG. 22 shows a schematic diagram of a device for extracting coordinates of an individual character provided in the present disclosure, and the specific embodiment of the present disclosure does not limit a specific implementation of the device for extracting coordinates of an individual character.

As shown in FIG. 22, the device for extracting coordinates of an individual character may include a processor 502, a communication interface 504, a memory 506, and a communication bus 508.

Wherein the processor 502, the communication interface 504, and the memory 506 communicate with each other through the communication bus 508. The communication interface 504 is configured to communicate with network elements of other devices such as clients or other servers. The processor 502 is configured to execute the program 510 and may specifically perform the relevant operations in the aforementioned embodiments.

In particular, program 510 may include program codes that include computer-executable instructions.

The processor 502 may be a Central Processing Unit (CPU), or an Application Specific Integrated Circuit (ASIC), or one or more integrated circuits configured to implement embodiments of the present disclosure. The device includes one or more processors, which may be processors of the same type, such as one or more CPUs; they may also be different types of processors, such as one or more CPUs and one or more ASICs.

The memory 506 is configured to store the program 510. Memory 506 may include high-speed RAM memory, and may also include non-volatile memory, such as at least one disk memory.

Embodiments of the present disclosure provide a computer-readable storage medium having stored thereon at least one executable instruction that, when executed on a device for extracting coordinates of an individual character, causes the device/apparatus for extracting coordinates of an individual character to perform the method for extracting coordinates of characters in any of the above method embodiments.

Embodiments of the present disclosure provide a computer program which can be invoked by a processor to cause the device for extracting coordinates of an individual character to perform the method for extracting coordinates of characters in any of the above method embodiments.

Embodiments of the present disclosure provide a computer program product, where the computer program product includes computer readable codes, or a non-volatile computer-readable storage medium carrying the computer readable codes. When the computer readable codes are executed on a processor of an electronic device, the processor of the electronic device is caused to perform the method for extracting coordinates of characters in any of the above method embodiments.

Technical schemes of the present disclosure may be implemented as a system, method and/or computer program product. The computer program product may include a computer-readable storage medium uploaded with computer readable program instructions for causing the processor to implement various aspects of the present disclosure.

The computer-readable storage medium may be a tangible device that can hold and store instructions used by the instruction execution device. The computer-readable storage medium may, for example, be (but not limited to) an electrical storage device, a magnetic storage device, an optical storage device, an electromagnetic storage device, a semiconductor storage device, or any suitable combination of the above. More specific examples (non-exhaustive list) of computer readable storage media include portable computer disk, hard disk, Random Access Memory (RAM), ROM, EPROM or flash memory, SRAM, Compact Disc-Read Only Memory (CD-ROM), Digital Versatile Disc (DVD), memory stick, floppy disk, mechanical coding device, such as punch card or in-groove structure on which instruction is stored, and any suitable combination of the above.

The computer-readable storage medium used herein is not interpreted as an instantaneous signal per se, such as radio waves or other freely propagating electromagnetic waves, electromagnetic waves (e.g., light pulses through fiber optic cables) propagating through waveguides or other transmission media, or electrical signals propagating through electrical wires.

The computer readable program instructions described herein may be downloaded from a computer-readable storage medium to various computing/processing devices, or downloaded to an external computer or external storage device over a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer readable program instructions from the network and forwards the computer readable program instructions for storage in a computer-readable storage medium in each computing/processing device.

Computer program instructions for performing the operations of embodiments of the present disclosure may be assembly instructions, Instruction Set Architecture (ISA) instructions, machine instructions, machine-related instructions, microcode, firmware instructions, state setting data, or source code or object code written in any combination of one or more programming languages, including object-oriented programming languages, such as Smalltalk, C++, etc., and conventional procedural programming languages, such as “C” language or the like. Computer readable program instructions may be executed entirely on the user computer, partly on the user computer, as a stand-alone software package, partly on the user computer and partly on a remote computer, or entirely on a remote computer or server. In the case of a remote computer, the remote computer may be connected to a user computer over any kind of network, including a Local Area Network (LAN) or a Wide Area Network (WAN), or may be connected to an external computer (e.g. use an Internet service provider to connect through the Internet). In some embodiments, an electronic circuit, such as a programmable logic circuit, Field Programmable Gate Array (FPGA), or Programmable Logic Arrays (PLA), is customized using state information of a computer readable program instruction, and the customized electronic circuit may execute a computer readable program instruction to perform various aspects of the present disclosure.

Aspects of the present disclosure are described herein with reference to flowcharts and/or block diagrams of methods, devices (systems), and computer program products according to embodiments of the present disclosure. It is to be understood that each block of the flowchart and/or block diagram and the combination of the blocks in the flowchart and/or block diagram may be implemented by computer readable program instructions.

These computer readable program instructions may be provided to a processor of a general purpose computer, a special purpose computer, or other programmable data processing device, thereby producing a machine such that the instructions, when executed by the processor of the computer or other programmable data processing device, produce a device for implementing the functions/actions specified in one or more blocks in the flowchart and/or block diagram. The computer readable program instructions may also be stored in a computer-readable storage medium, the computer readable program instructions cause a computer, programmable data processing device and/or other device to operate in a particular manner, so that the computer-readable medium storing the instructions includes a manufacture that includes instructions for implementing various aspects of the functions/actions specified in one or more blocks in the flowcharts and/or block diagrams.

It is also possible to load computer readable program instructions onto a computer, other programmable data processing device, or other device such that a series of operational steps are performed on the computer, other programmable data processing device, or other device to produce a computer-implemented process such that the instructions executed on the computer, other programmable data processing device, or other device implement the functions/actions specified in one or more blocks in the flowchart and/or block diagram.

The flowcharts and block diagrams in the drawings illustrate the architectures, functions, and operations of possible implementations of systems, methods, and computer program products according to various embodiments of the present disclosure. In this regard, each block in the flowchart or block diagram may represent a portion of a module, program segment, or instruction that contains one or more executable instructions configured to implement a specified logical function. In some alternative implementations, the functions labeled in the blocks may also occur in a different order than those labeled in the drawings. For example, two consecutive blocks can actually be executed essentially in parallel, and they can sometimes be executed in a reverse order, depending on the function involved. It is also noted that each block in the block diagram and/or flow diagram, and a combination of blocks in the block diagram and/or flow diagram, may be implemented with a dedicated hardware-based system that performs a prescribed function or action, or may be implemented with a combination of dedicated hardware and computer instructions.

The computer program product may be implemented specifically by means of hardware, software, or a combination thereof. In one alternative embodiment, the computer program product is embodied as a computer storage medium, and in another alternative embodiment, the computer program product is embodied as a software product, such as a Software Development Kit (SDK) or the like.

The above description of the various embodiments tends to emphasize the differences between the various embodiments, the similarities or resemblances of which may be referred to each other, and will not be repeated herein for the sake of brevity.

Those skilled in the field will understand that in the above-mentioned method in the specific embodiment, the writing order of each step does not imply a strict execution order and constitutes any limitation on the implementation process, and the specific execution order of each step should be determined by its function and possible internal logic.

If the technical schemes of the embodiment of the present disclosure involve personal information, the product applying the technical schemes of the embodiment of the present disclosure have clearly informed the personal information processing rules before processing personal information, and obtained the individual's independent consent.

If the technical scheme of the embodiment of the present disclosure involves sensitive personal information, the product applying the technical scheme of the embodiment of the present disclosure has obtained individual consent before processing sensitive personal information, and at the same time meets the requirement of “express consent”. For example, on personal information collection devices such as cameras, a clear and prominent identifier is set up to inform the entry into the scope of personal information collection, and to inform that personal information will be collected. If an individual voluntarily enters the scope of collection, it is deemed that he/she agrees to have his/her personal information collected; or on the personal information processing device, in the case of using obvious identifier/information to inform the personal information processing rules, personal authorization is obtained through pop-up information or requesting individuals to upload their personal information by themselves. The personal information processing rules may include personal information handlers, personal information processing purposes, processing methods, types of personal information processed, etc.

Embodiments of the present disclosure have been described above and the above description is exemplarily and is not exhaustive and is not limited to the disclosed embodiments. Without departing from the scope and spirit of the illustrated embodiments, many modifications and alterations are apparent to a person of ordinary skill in the field. The terms used herein are chosen to best explain the principles or practical applications of the embodiment or improvements to the technologies in the market, or to enable other persons of ordinary skill in the field to understand the embodiments disclosed herein.

### INDUSTRIAL APPLICABILITY

The present disclosure discloses a character coordinate extraction method and apparatus, a device, a medium and a program product. The method includes: a target text image is input into a feature extraction backbone network, and a character segmentation feature and a text line segmentation feature are acquired through feature fusion by different layers in the backbone network; the character segmentation feature and the text line segmentation feature are input respectively into a character segmentation module and a text line segmentation module, and a character segmentation heat map and a text segmentation heat map of the target text image are acquired; and coordinates of an individual character in the target text image are calculated according to the character segmentation heat map and the text segmentation heat map.

1. A method for extracting coordinates of characters, comprising:
inputting a target text image into a feature extraction backbone network, and acquiring a character segmentation feature and a text line segmentation feature through feature fusion by different layers in the feature extraction backbone network;
inputting the character segmentation feature and the text line segmentation feature respectively into a character segmentation module and a text line segmentation module, and acquiring a character segmentation heat map and a text line segmentation heat map of the target text image, wherein the character segmentation module and the text line segmentation module form a segmentation network model; and
calculating coordinates of an individual character in the target text image according to the character segmentation heat map and the text line segmentation heat map.

2. The method of claim 1, wherein the inputting the target text image into the feature extraction backbone network and acquiring the character segmentation feature and the text line segmentation feature through the feature fusion of the different layer in the feature extraction backbone network comprises:
inputting the target text image into the feature extraction backbone network;
extracting feature maps of the target text image using the feature extraction backbone network; and
fusing extracted feature maps through a Feature Pyramid Network (FPN), to acquire the character segmentation feature and the text line segmentation feature.

3. The method of claim 1, wherein the inputting the character segmentation feature and the text line segmentation feature respectively into the character segmentation module and the text line segmentation module and acquiring the character segmentation heat map and the text line segmentation heat map of the target text image comprises:
inputting the character segmentation feature into the character segmentation module to obtain a character segmentation probability map and a character segmentation threshold map;
calculating the character segmentation heat map according to a difference between the character segmentation probability map and the character segmentation threshold map;
inputting the text line segmentation feature into the text line segmentation module to obtain a text line segmentation probability map and a text line segmentation threshold map; and
calculating the text line segmentation heat map according to a difference between the text line segmentation probability map and the text line segmentation threshold map.

4. The method of claim 1, wherein the calculating the coordinates of the individual character in the target text image according to the character segmentation heat map and the text line segmentation heat map comprises:
acquiring bounding box position information of a text line from the text line segmentation heat map;
cropping the character segmentation heat map according to the bounding box position information of the text line to obtain a text line picture;
segmenting the text line picture through a watershed algorithm to form segmented images, and acquiring a number of the segmented images;
recognizing a number of characters in the text line picture through Connectionist Temporal Classification (CTC);
comparing the number of the segmented images obtained through the watershed algorithm with the number of characters recognized through the CTC;
acquiring position information of each character through the watershed algorithm when the number of the segmented images is identical to the number of the characters;
restoring the position information of each character to the target text image to obtain coordinates of each character; and
extracting the coordinates of the individual character from the CTC when the number of the segmented images is different from the number of the characters.

5. The method of claim 4, wherein the extracting the coordinates of the individual character from the CTC when the number of the segmented images is different from the number of characters comprises:
slicing uniformly the text line picture based on the CTC to form at least one sliced image block,
recognizing the at least one sliced image block to obtain a character corresponding to each sliced image block, and marking an unrecognized sliced image block as a special character;
merging the sliced image blocks corresponding to a same character to form a merged image block;
slicing from a ½ position of the merged image block to obtain a slicing result of each character; and
mapping the slicing result of the character to the text line picture to obtain a text box, and to obtain CTC-based coordinate information of the individual character.

6. The method of claim 3, further comprising: training the segmentation network model, wherein before the training the segmentation network model, the method further comprises:
preparing training data, wherein the training data comprises position information of each character and position information of an entire text line; the position information of each character is configured to train an individual character segmentation module; and
the position information of the entire text line is configured to train the text line segmentation module.

7. The method of claim 6, wherein the training the segmentation network model comprises:
designing a joint training loss function, and training the segmentation network model according to the joint training loss function,
wherein a formula for calculating the joint training loss function is:
$$Loss = {αloss}_{char} + {βloss}_{textline} ;$$
where α and, β are constant coefficients;
each of loss_{char} and lossₜₑₓₜₗᵢₙₑ comprises a segmentation graph loss L_{S} and a threshold map loss Lₜ of the character and the text line:
$${loss}_{char} = {α}_{1} {L}_{S 1} + {β}_{1} {L}_{t 1} ; {loss}_{textline} = {α}_{2} {L}_{S 2} + {β}_{2} {L}_{t 2} ;$$
where β₁, α₂, β₁, β₂ are constant coefficients;
the character segmentation probability map and the text line segmentation probability map in the joint training loss function adopt bi-classification cross-entropy loss functions, and inputs of loss functions L_{S1} and L_{S2} are a sample prediction probability map and a sample true label map:
$${L}_{S 1} = {L}_{S 2} = {\sum }_{i ∈ {S}_{1}} {y}_{i} log {x}_{i} + ( 1 - {y}_{i} ) log ( 1 - {x}_{i} ) ;$$
where Sᵢ is a sample set, xᵢ is a probability value of a pixel in the sample prediction probability map, y, is a true value of the pixel of a true label of a sample;
inputs of loss functions Lₜ₁ and Lₜ₂ are a threshold map of a predicted text line and a sample true label map, and the threshold map adopts L1 distance loss function:
$${L}_{t 1} = {L}_{t 2} = {\sum }_{i ∈ {R}_{d}} \vert {y}_{i}^{*} - {x}_{i}^{*} \vert ;$$
where R_{d} is a pixel index set in the threshold map, yᵢ* is the sample true label map, xᵢ* is the threshold map of the predicted text line.

8. An apparatus for extracting coordinates of characters, comprising:
a processor;
a memory for storing executable instructions;
a communication interface; and
a communication bus,
wherein the processor, the memory and the communication interface perform mutual communication through the communication bus; and
wherein the processor is configured to execute the executable instructions to perform operations comprising:
inputting a target text image into a feature extraction backbone network;
acquiring a character segmentation feature and a text line segmentation feature;
inputting the character segmentation feature and the text line segmentation feature respectively into a character segmentation module and a text line segmentation module, wherein the character segmentation module and the text line segmentation module form a segmentation network model;
acquiring a character segmentation heat map of the target text image;
acquiring a text line segmentation heat map of the target text image; and
calculating coordinates of an individual character in the target text image according to the character segmentation heat map and the text line segmentation heat map.

9. The apparatus of claim 8, wherein the processor is further configured to:
input the target text image into the feature extraction backbone network;
extract feature maps of the target text image using the feature extraction backbone network; and
fuse the extracted feature maps through a Feature Pyramid Network (FPN) to acquire the character segmentation feature and the text line segmentation feature.

10. The apparatus of claim 8, herein the processor is further configured to:
input the character segmentation feature into the character segmentation module to obtain a character segmentation probability map and a character segmentation threshold map;
calculate the character segmentation heat map according to a difference between the character segmentation probability map and the character segmentation threshold map;
input the text line segmentation feature into the text line segmentation module to obtain a text line segmentation probability map and a text line segmentation threshold map; and
calculate the text line segmentation heat map according to a difference between the text line segmentation probability map and the text line segmentation threshold map.

11. The apparatus of claim 8, wherein the processor is further configured to:
acquire bounding box position information of a text line from the text line segmentation heat map;
crop the character segmentation heat map according to the bounding box position information of the text line to obtain a text line picture;
segment the text line picture through a watershed algorithm to form segmented images, and acquire a number of the segmented images;
recognize a number of characters in the text line picture through Connectionist Temporal Classification (CTC);
compare the number of the segmented images obtained through the watershed algorithm with the number of characters recognized through the CTC;
acquire position information of each character through the watershed algorithm when the number of the segmented images is identical to the number of characters;
restore the position information of each character to the target text image to obtain coordinates of each character; and
extract the coordinates of the individual character from the CTC when the number of the segmented images is different from the number of the characters.

12. The apparatus of claim 11, wherein the processor is further configured to:
uniformly slice the text line picture based on the CTC to form at least one sliced image block;
recognize the at least one sliced image block to obtain a character corresponding to each sliced image block, and mark an unrecognized sliced image block as a special character;
merge the sliced image blocks corresponding to a same character to form a merged image block;
segment from a ½ position of the merged image block to obtain a slicing result of each character; and
map the slicing result of the character to the text line picture to obtain a text box, and obtain CTC-based coordinate information of the individual character.

13. The apparatus of claim 10, wherein the processor is further configured to prepare training data, wherein the training data comprises position information of each character and position information of an entire text line; the position information of each character is configured to train an individual character segmentation module; and the position information of the entire text line is configured to train the text line segmentation module.

14. The apparatus of claim 13, wherein the processor is further configured to:
design a joint training loss function, and train the segmentation network model according to the joint training loss function,
wherein a formula for calculating the joint training loss function is:
$$Loss = {αloss}_{char} + {βloss}_{textline} ;$$
wherein, α and β are constant coefficients;
each of loss_{char} and lossₜₑₓₜₗᵢₙₑ comprises respectively a segmentation graph loss L_{S} and a threshold map loss Lₜ of the character and the text line:
$${loss}_{char} = {α}_{1} {L}_{S 1} + {β}_{1} {L}_{t 1} ; {loss}_{textline} = {α}_{2} {L}_{S 2} + {β}_{2} {L}_{t 2} ;$$
where α₁, α₂, β₁, β₂ are constant coefficients;
the character segmentation probability map and the text line segmentation probability map in the joint training loss function adopt bi-classification cross-entropy loss functions, and inputs of loss functions L_{S1} and L_{S2} are a sample prediction probability map and a sample true label map:
$${L}_{S 1} = {L}_{S 2} = {\sum }_{i ∈ {S}_{1}} {y}_{i} log {x}_{i} + ( 1 - {y}_{i} ) log ( 1 - {x}_{i} ) ;$$
where Sᵢ is a sample set, xᵢ is a probability value of a pixel in the sample prediction probability map, yᵢ is a true value of the pixel of a true label of a sample;
inputs of loss functions Lₜ₁ and Lₜ₂ are a threshold map of a predicted text line and a sample true label map, and the threshold map adopts L1 distance
$${L}_{t 1} = {L}_{t 2} = {\sum }_{i ∈ {R}_{d}} \vert {y}_{i}^{*} - {x}_{i}^{*} \vert ;$$
wherein, R_{d} is a pixel index set in the threshold map, yᵢ* is the sample true label map, xᵢ* is the threshold map of the predicted text line.

15. (canceled)

16. A non-transitory computer-readable storage medium having stored thereon at least one executable instruction that, when executed on a device for extracting coordinates of characters, causes the device to perform operations comprising:
inputting a target text image into a feature extraction backbone network, and acquiring a character segmentation feature and a text line segmentation feature through feature fusion by different layers in the feature extraction backbone network:
inputting the character segmentation feature and the text line segmentation feature respectively into a character segmentation module and a text line segmentation module, and acquiring a character segmentation heat map and a text line segmentation heat map of the target text image, wherein the character segmentation module and the text line segmentation module form a segmentation network model; and
calculating coordinates of an individual character in the target text image according to the character segmentation heat map and the text line segmentation heat map.

17. (canceled)

18. (canceled)

19. The non-transitory computer-readable storage medium of claim 16, wherein when executed on the device for extracting coordinates of characters, the at least one executable instruction causes the device to perform operations further comprising:
inputting the target text image into the feature extraction backbone network;
extracting feature maps of the target text image using the feature extraction backbone network; and
fusing extracted feature maps through a Feature Pyramid Network (FPN), to acquire the character segmentation feature and the text line segmentation feature.

20. The non-transitory computer-readable storage medium of claim 16, wherein when executed on the device for extracting coordinates of characters, the at least one executable instruction causes the device to perform operations further comprising:
inputting the character segmentation feature into the character segmentation module to obtain a character segmentation probability map and a character segmentation threshold map;
calculating the character segmentation heat map according to a difference between the character segmentation probability map and the character segmentation threshold map;
inputting the text line segmentation feature into the text line segmentation module to obtain a text line segmentation probability map and a text line segmentation threshold map; and
calculating the text line segmentation heat map according to a difference between the text line segmentation probability map and the text line segmentation threshold map.

21. The non-transitory computer-readable storage medium of claim 16, wherein when executed on the device for extracting coordinates of characters, the at least one executable instruction causes the device to perform operations further comprising:
acquiring bounding box position information of a text line from the text line segmentation heat map;
cropping the character segmentation heat map according to the bounding box position information of the text line to obtain a text line picture;
segmenting the text line picture through a watershed algorithm to form segmented images, and acquiring a number of the segmented images;
recognizing a number of characters in the text line picture through Connectionist Temporal Classification (CTC);
comparing the number of the segmented images obtained through the watershed algorithm with the number of characters recognized through the CTC;
acquiring position information of each character through the watershed algorithm when the number of the segmented images is identical to the number of the characters;
restoring the position information of each character to the target text image to obtain coordinates of each character; and
extracting the coordinates of the individual character from the CTC when the number of the segmented images is different from the number of the characters.

22. The non-transitory computer-readable storage medium of claim 21, wherein the extracting the coordinates of the individual character from the CTC when the number of the segmented images is different from the number of characters comprises:
slicing uniformly the text line picture based on the CTC to form at least one sliced image block,
recognizing the at least one sliced image block to obtain a character corresponding to each sliced image block, and marking an unrecognized sliced image block as a special character;
merging the sliced image blocks corresponding to a same character to form a merged image block;
slicing from a ½ position of the merged image block to obtain a slicing result of each character; and
mapping the slicing result of the character to the text line picture to obtain a text box, and to obtain CTC-based coordinate information of the individual character.

23. The non-transitory computer-readable storage medium of claim 20, wherein when executed on the device for extracting coordinates of characters, the at least one executable instruction causes the device to perform operations further comprising:
preparing training data, wherein the training data comprises position information of each character and position information of an entire text line; the position information of each character is configured to train an individual character segmentation module; and the position information of the entire text line is configured to train the text line segmentation module.
